(19) United States
(12) Patent Application Publication
(10) Pub. No.: US 2020/0369837 A1
(43) Pub. Date: Nov. 26, 2020

(54) COMPOSITE ARTICLE COMPRISING A METAL REINFORCEMENT ELEMENT

(71) Applicant: NV Bekaert SA, Zwevegem (BE)

(72) Inventors: Meenali PARSEKAR, Veldhoven (NL); Maarten VIERSTRAETE, Heule (BE); Elbia STARLING, Comines (FR)

(73) Assignee: NV Bekaert SA, Zwevegem (BE)

(21) Appl. No.: 16/959,303

(22) PCT Filed: Feb. 5, 2019
(86) PCT No.: PCT/EP2019/052760

§ 371 Date: Jun. 30, 2020

(30) Foreign Application Priority Data
Feb. 14, 2018 (EP) 18156617.5

(51) Int. Cl. C08J 5/04; C08J 5/06; C08L 23/06; D07B 1/06

(52) U.S. Cl. CPC C08J 5/041; C08J 5/06; C08L 23/06; D07B 1/0666; D07B 2201/2012; D07B 2201/2011; D07B 2501/2076; D07B 2201/2043; D07B 2201/2044; D07B 2201/2045; D07B 2205/201; D07B 2205/3071; D07B 2201/2013

(57) ABSTRACT

A composite article comprising at least one metal reinforcement element embedded in a polymer material, said metal reinforcement element being at least partially coated with an adhesion promoting layer, said adhesion promoting layer being interposed between said metal reinforcement element and said polymer material, characterized in that said adhesion promoting layer comprises an acid anhydride-grafted polyolefin and a phenolic antioxidant.

### TECHNICAL FIELD

The invention relates to a composite article comprising at least one metal reinforcement element embedded in a thermoplastic polymer material and the metal reinforcement element. The invention further relates to a method of manufacturing a composite article and to the use of such a composite article as reinforced article.

### BACKGROUND ART

Metal reinforced polymer materials are attractive for many applications as they combine high strength and light weight. However, a well-known problem associated with metal reinforced polymer materials, and more particularly non polar thermoplastic polymer materials such as polyolefins, is the difficulty to obtain a good adhesion between the metal reinforcement element and the thermoplastic polymer material.

Many researchers attempted to promote the adhesion between the metal and the polymer material. Attempts comprise for example the modification of the bulk polymer or the physico-chemical modification of one or both constituent's surfaces. Maleic anhydride is for example industrially used for increasing the functionality of the polymer in order to enhance the adhesion between steel and polymer. Coupling agents, such as silanes, have been proposed to improve the adhesion between the metal and the polymer material. Also epoxy and chromium based coatings are known in the art to increase the corrosion resistance and to promote adhesion between the metal surface and the polymer coatings.

However, these coatings show a number of drawbacks. Epoxy based coatings for example absorbs moisture easily. Due to the diffusion of the absorbed water into the epoxy-steel interface the interfacial adhesion strength may be weakened. Chromium based coatings on the other hand are highly toxic so that their application is preferably avoided.

As for many applications a high corrosion resistance is desired, additional treatments are necessary.

### DISCLOSURE OF INVENTION

It is an object of the present invention to avoid the drawbacks of the prior art.

It is another object of the present invention to improve the metal-polymer material bond by means of an adhesion promoting layer.

It is also an object of the invention to improve the resistance against ageing, corrosion, dynamic loads and shear forces acting across the interface.

It is a further object of the present invention to create a toughened interphase between a metal reinforcement element and a polymer matrix.

According to the present invention a composite article comprising at least one metal reinforcement element embedded in a polymer material is provided.

The metal reinforcement element is at least partially coated with an adhesion promoting layer. This adhesion promoting layer is interposed between the metal reinforcement element and the polymer material.

Preferably, the major surface, e.g. more than 80 percent of the whole surface, of metal reinforcement element is homogenously coated with the adhesion promoting layer.

The metal reinforcement element may be an elongated element, such as a bar or wire, having a longitudinal direction along its length. In such case, the elongated metal reinforcement element is preferably completely coated along its longitudinal direction with the adhesion promoting layer. The two ends of the elongated metal reinforcement element perpendicular to the longitudinal direction may be not coated with the adhesion promoting layer.

Metal Reinforcement Element

As metal reinforcement element, a metal wire, metal cord, a metal strip or ribbon can be considered. Metal wires may have any cross-section such as a circular, oval or flat (rectangular) cross-section. The equivalent diameter of an elongated metal reinforcement element may be in a range of 0.2 to 5 mm. Depending on the applications, the equivalent diameter of an elongated metal reinforcement element may be in a range of 0.4 to 1.5 mm or in a range of 2.0 to 3.0 mm.

It may be desired to use metal wires or cords having a structural elongation.

Also structures comprising a number of metal wires can be considered as metal reinforcement element. Examples comprise bundled, braided, welded or woven structures comprising a number of metal elements.

Any metal or metal alloy can be used to provide the metal reinforcement elements of the composite article according to the invention. Preferably, the metals or metal alloys are selected from iron, titanium, aluminum, copper and alloys thereof.

The tensile strength of a metal element is preferably higher than 1000 N/mm². As a preferred example, the metal reinforcement element is made out of steel. The tensile strength of the steel reinforcement element can range from 500 N/mm² to 4000 N/mm², and is mainly dependent upon the composition of the steel, the diameter of the elements and manufacture process of the steel reinforcement element.

The steel reinforcement element can be made from carbon steel. The steel may have the following steel composition: a carbon content ranging between 0.2 wt % and 1.2 wt %, a manganese content from 0.3 wt % to 0.80 wt %, a silicon content ranging from 0.10 wt % to 0.50 wt %, a maximum sulphur content of 0.05 wt %, a maximum phosphorus content of 0.05 wt %, the remainder being iron and possible traces of copper, chromium, nickel, vanadium, molybdenum or boron. Alternatively, the steel reinforcement element may be made out of a low carbon wire rod with a carbon content ranging between 0.04 wt % and 0.20 wt %. Also stainless steels are applicable. Stainless steels contain a minimum of 12 wt % Cr and a substantial amount of nickel. The possible compositions are known in the art as AISI (American Iron and Steel Institute) 25 302, AISI 301, AISI 304 and AISI 316.

The metal reinforcement element or the structure comprising a number of metal elements can be coated with one or more metal or metal alloy coating before the adhesion promoting layer is applied. Preferred metal or metal alloy coatings comprise zinc and zinc alloy coatings such as zinc-copper, zinc-aluminium, zinc-manganese, zinc-cobalt alloy, zinc-nickel alloy, zinc iron alloy or zinc-tin alloy coatings.

A preferred zinc-aluminium coating comprises 2 to 10 wt % aluminum and 0.2 to 3.0 wt % magnesium, the remainder being zinc. An example is 5 wt % aluminum, 0.5 wt % magnesium and the rest being zinc.

For some applications, it can be desired to use hybrid structures, i.e. structures combining two or more different materials such as structures comprising metal wires of two or more different metals or metal alloys or comprising metal wires in combination with non-metal filaments such as polymer filaments or glass filaments.

As an example, a metal reinforcement element comprises a cord having a polymer core as inner filament and metal wires, such as steel wires, as outer filaments.

As another example, a metal reinforcement element comprises a woven structure comprising metal filaments and polymer filaments.

Polymer Material

Any polymer can be considered as polymer material. Preferred polymers comprise thermoplastic polymers. Examples of suitable polymers comprise polyolefins; polyamides; polyurethanes; polyesters; rubbers such as polyisoprene, chloroprene, styrene-butadiene, butyl rubber, nitrile and hydrogenetated nitrile rubbers, EPDM, ABS (acrylonitrile butadiene styrene) and PVC.

Polyolefin can include any polymer comprising repeat units derived from an olefin and includes polyethylene (PE), polypropylene (PP), polybutylene (PB), polyisobutylene, polymethylpentene (PMP), polybutene-1 (PB-1) and a copolymer of any of these polyolefins.

The polymer material can also be thermoplastics e.g. polystyrene (PS), polyethylene terephthalate (PET), polyethylene napthalate (PEN), polybuteen terephthalate (PBT) polyvinylchloride (PVC), polyamide (PA), polyester (PES), polyimide (PI), polycarbonate (PC), styrene acrilonitryl (SAN), acrylonitril-butadiene-styrene (ABS), copolyetheresters, copolymers of these polymers or similar materials.

Adhesion Promotion Layer

An adhesion promotion layer is provided on the metal reinforcement element. The thickness of the adhesion promotion layer is in a range from 5 to 500 μm. The elongated metal reinforcement element may have an equivalent diameter in a range of 0.4 mm to 3 mm. Preferably, the adhesion promotion layer has a thickness in a range from 10 to 50 μm on an elongated metal reinforcement element having an equivalent diameter in a range of 0.4 to 1.5 mm. Preferably, the adhesion promotion layer has a thickness in a range from 80 to 150 μm on an elongated metal reinforcement element having an equivalent diameter in a range of 2.0 to 3.0 mm.

The adhesion promoting layer comprises an acid anhydride-grafted polyolefin and a phenolic antioxidant. The adhesion promoting layer may also comprise a reaction product of the acid anhydride-grafted polyolefin and the phenolic antioxidant.

Acid Anhydride-Grafted Polyolefin

Graft polymers are segmented copolymers with a linear backbone of one composite and randomly distributed branches of another composite.

The acid anhydride can include any acid anhydride, its monoester, or combinations thereof. Examples of acid anhydride include maleic anhydride, monoester of maleic anhydride, succinic anhydride, monoester of succinic anhydride, fumaric anhydride, monoester of fumaric anhydride, or combinations of two or more thereof.

Polyolefin can include any polymer comprising repeat units derived from an olefin and includes polyethylene (PE), polypropylene (PP), polybutylene (PB), polyisobutylene, polymethylpentene (PMP), polybutene-1 (PB-1) and a copolymer of any of these polyolefins. Such copolymer can include comonomers including butene, hexene, octene, decene, dodecene, or combinations of two or more thereof.

As an example, polyethylene polymers can include high density polyethylene (HDPE), linear low density polyethylene (LLDPE), very low or ultra-low density polyethylenes (VLDPE or ULDPE), low density polyethylene (LDPE) or combinations of two or more thereof.

The acid anhydride can be present in the adhesion promoting layer, based on the concentration of acid anhydride, e.g. from about 0.05 wt % to 5 wt %, preferably in a range from 0.1 to 2.0 wt %, and more preferably in a range from 0.5 to 1.0 wt %.

Acid anhydride-grafted polyolefin can be prepared by any means known to one skilled in the art. For instance, the grafted polyolefin can be prepared by the most frequently used synthesis methods e.g. “grafting to”, “grafting from”, and “grafting through”, which are used to construct a graft polymer.

Phenolic Antioxidant

The phenolic antioxidant is present in the adhesion promoting layer based on a concentration lower than 20 wt %. More preferably, the concentration of the phenolic antioxidant is lower than 5 wt %, for example 2 wt % or 1 wt %.

Examples of the phenolic antioxidant include 2,6-di-tert-butyl-p-cresol, 2,6-diphenyl-4-octadecyloxyphenol, stearyl(3,5-di-tert-butyl-4-hydroxyphenyl)propionate, distearyl(3,5-di-tert-butyl-4-hydroxybenzyl)phosphonate, tridecyl-3,5-di-tert-butyl-4-hydroxybenzyl thioacetate, thiodiethylene-bis[(3,5-di-tert-butyl-4-hydroxyphenyl)propionate], 4,4′-thiobis(6-tert-butyl-m-cresol), 2-octylthio-4,6-di(3,5-di-tert-butyl-4-hydroxyphenoxy)-s-triazine, 2,2′-methylene-bis(4-methyl-6-tert-butylphenol), bis[3,3-bis(4-hydroxy-3-tert-butylphenyl)butyric acid]glycol ester, 4,4′-butylidene-bis(4,6-di-tert-butylphenol), 2,2′-ethylidene-bis(4,6-di-tert-butylphenol), 1,1,3-tris(2-methyl-4-hydroxy-5-tert-butylphenyl)butane, bis[2-tert-butyl-4-methyl-6-(2-hydroxy-3-tert-butyl-5-methylbenzy)phenyl]terephthalate, 1,3,5-tris(2,6-dimethyl-3-hydroxy-4-tert-butylbenzyl)isocyanurate, 1,3,5-tris(3,5-di-tert-butyl-4-hydroxybenzyl)isocyanurate, 1,3,5-tris(3,5-di-tert-butyl-4-hydroxybenzyl)-2,4,6-trimethylbenzene, 1,3,5-tris[(3,5-di-tert-butyl-4-hydroxyphenyl)propionyloxyethyl]isocyanurate, tetrakis[methylene-3-(3,5-di-tert-butyl-4-hydroxyphenyl)propionate]methane, 2-tert-butyl-4-methyl-6-(2-acryloyloxy-3-tert-butyl-5-methylbenzyl)phenol, 3,9-bis[2-{3-(3-tert-butyl-4-hydroxy-5-methylphenyl)propanoyloxy}-1,1-dimethylethyl]-2,4,8,10-tetraoxaspiro[5.5]undecane and triethylene glycol-bis[β-(3-tert-butyl-4-hydroxy-5-methylphenyl)propionate].

The phenolic antioxidant used in the present invention can be a butylated hydroxytoluene which is an organic chemical composed of 4-methylphenol modified with tert-butyl groups at positions 2 and 6. Butylated hydroxytoluene inhibits autoxidation of unsaturated organic compounds. Representative examples of the phenolic antioxidant used in the invention are 2,6-di-tert-butyl-4-methylphenol, 2,6-di-tert-butylphenol, 2,6-d-tert-butyl-4-s-butylphenol, mixture of alkylated phenols or 4,4′-methylene-bis(2,6-di-ter-butylphenol) or a combination of two or more thereof. The combination of maleic acid anhydride and 2,6-di-tert-butyl-4-methylphenol, 2,6-di-tert-butylphenol, 2,6-d-tert-butyl-4-s-butylphenol, mixture of alkylated phenols or 4,4′-methylene-bis(2,6-di-ter-butylphenol) or their combination surprisingly provides more stable adhesion between a polymer material and metal. Moreover, the adhesion remains over a long time.

According to the present invention, a method to manufacture a composite article is provided. The method comprises the steps of:
a) providing a metal reinforcement element;
b) applying an adhesion promoting layer on at least a part of said metal reinforcement element, said adhesion promoting layer comprising an acid anhydride-grafted polyolefin and a phenolic antioxidant selected from 2,6-di-tert-butyl-4-methylphenol, 2,6-di-tert-butylphenol, 2,6-d-tert-butyl-4-s-butylphenol, mixture of alkylated phenols or 4,4′-methylene-bis(2,6-di-ter-butylphenol) or a combination including any of these phenolic antioxidants;
c) embedding said metal reinforcement element coated with said adhesion promoting layer in a polymer material.

An adhesion promoting layer may be applied by means of any available coating techniques on said metal reinforcement element. As a preferred example, an adhesion promoting layer may be applied by means of extrusion. The adhesion promoting layer can be applied in a prehydrolized or non-hydrolized form.

The method may further comprise the step of
d) applying a metal or metal alloy coating, e.g. zinc or a zinc alloy, before the application of said adhesion promoting layer.

According to another aspect of the present invention, the use of a composite article as described above for all kind of applications requiring a metal reinforced polymer is provided. A composite article according to the present invention can be used for furniture, drop cables, power transmission cables, automotive or constructions.

### MODE(S) FOR CARRYING OUT THE INVENTION

A composite article comprising a steel wire in a polymer matrix material is made according to the present invention. The steel wire is extruded with an adhesion promoting layer comprising an acid anhydride-grafted polyolefin and a phenolic antioxidant. The acid anhydride-grafted polyolefin is preferably maleic acid anhydride-grafted polyethylene with maleic acid anhydride present in a concentration from 0.5 to 1.0 wt %. The phenolic antioxidant is for example 2,6-di-tert-butyl-4-methylphenol type, 2,6-di-tert-butylphenol type, 2,6-d-tert-butyl-4-s-butylphenol type, 4,4′-methylene-bis(2,6-di-ter-butylphenol) type, mixture of alkylated phenols or the combination of the above, and in a concentration less than 2 wt %, preferably less than 1 wt %. The adherence between the steel wire and the adhesion promoting layer and the adherence between the adhesion promoting layer and the polymer matrix are investigated. These are also compared with samples using other adhesion promoting material as references. In order to test the adhesion between the adhesion promoting layer and the matrix, some of the coated steel wires are embedded in a polymer matrix. As an example, polyethylene with a thickness of at least 0.3 mm is used as matrix material and extruded on top of the adhesion promoting layer coated steel wires. The combination of maleic acid anhydride and 2,6-di-tert-butylphenol type, 2,6-d-tert-butyl-4-s-butylphenol type, 4,4′-methylene-bis(2,6-di-ter-butylphenol) type, mixture of alkylated phenols or the combination of the above provides more stable adhesion between the polymer matrix and the steel wire, and the adhesion remains over a long time.

The adherence at the interface of composite articles is assessed by mechanical procedure as described in the European standard NBN EN10245-1:2011 (E).

The procedure for testing adherence is as follows. Use a sharp knife to remove the organic coating in a longitudinal direction along a length of approximately 5 cm on two diametrically opposite sides of the wire. Use the back of the knife to lift a small portion of the coating, grasp with the fingers and try to tear the coating off. Allocate a value of 0 to 5 to the adherence, depending on the behaviour of the coating.
0 impossible to tear off the coating; the lifted portion breaks.
1 impossible to unstick the coating further; very small portions can only be unstuck using a knife.
2 only small particles less than 1 cm can be removed.
3 if you are careful you can remove pieces several cm long.
4 you can very easily remove several cm of coating.
5 the coating film no longer adheres once the coating has been cut at each side of the wire.

As the cleanness of the substrate has a significant impact on the coating, different cleaning step for the steel wire before the application of the adhesion promoting layer is also studied. The steel wires have soaps on their surface which were used during the drawing step. Cleaning steps may include steam degreasing (or steam cleaning), alkaline cleaning and acid pickling (or acid cleaning). In addition, ultrasonic leaning may also be applied. Galvanized steel wires having a diameter of 0.4 mm and 1.2 mm are respectively treated by different clean step and thereafter coated with different adhesion promoting layer by extrusion. Table 1 illustrates the adherence test results of galvanized steel wires with a diameter of 0.4 mm. Table 2 illustrates the adherence test results of galvanized steel wires with a diameter of 1.2 mm.

TABLE 1
adherence test results of galvanized steel wires with a diameter of 0.4 mm

| | | | | Coating |
|---|---|---|---|---|
| | | Adhesion level | Adhesion level | thickness of |
| Adhesion | | between steel wire | between adhesion | adhesion |
| promoting | | and adhesion | promoting layer | promoting |
| layer | Cleaning Step | promoting layer | and PE | layer (μm) |
| Invention | No cleaning | 2 or 3 | 1 | 31 |
| | steps | | | |
| Invention | All cleaning | 1 | 1 | 32 |
| | steps | | | |

TABLE 2
adherence test results of galvanized steel wires with a diameter of 1.2 mm

| | | | | Coating |
|---|---|---|---|---|
| | | Adhesion level | Adhesion level | thickness of |
| Adhesion | | between steel wire | between adhesion | adhesion |
| promoting | | and adhesion | promoting layer | promoting |
| layer | Cleaning Step | promoting layer | and PE | layer (μm) |
| Invention | No cleaning | 4 | Not done | 31.5 |
| | steps | | | |
| Invention | All cleaning | 1 | 1 | 32.5 |
| | steps | | | |
| Invention | Steam + acid | 1 | 1 | 31.5 |
| | bath | | | |
| Invention | Only steam | 1 | Not done | 29 |
| Invention | Ultrasonic | 1 | 1 | 38.5 |
| | cleaning | | | |
| Reference 1 | All cleaning | 3 | Not done | 33.5 |
| | steps | | | |
| Reference 2 | All cleaning | 4 | Not done | 90 |
| | steps | | | |

In table 1 and 2, “all cleaning steps” means the steel wire is subjected to steam degreasing (or steam cleaning), alkaline cleaning and acid pickling (or acid cleaning). It can be seen that the adhesion level between the steel wire and the adhesion promoting layer of the composites according to the present invention are “1” with various cleaning steps, while the reference samples are “3” or “4”. Also, according to the present invention, the adhesion level between the adhesion promoting layer and the polymer matrix is “1”. These test results verify that the composite article according to the invention has good adhesion between the metal reinforcement element and the embedded polymer material.

1-13. (canceled)

14. A composite article comprising at least one metal reinforcement element embedded in a polymer material, said metal reinforcement element being at least partially coated with an adhesion promoting layer, said adhesion promoting layer being interposed between said metal reinforcement element and said polymer material, characterized in that said adhesion promoting layer comprises an acid anhydride-grafted polyolefin and a phenolic antioxidant selected from 2,6-di-tert-butyl-4-methylphenol, 2,6-di-tert-butylphenol, 2,6-d-tert-butyl-4-s-butylphenol, mixture of alkylated phenols or 4,4′-methylene-bis(2,6-di-ter-butylphenol) or a combination including any of the above phenolic antioxidants.

15. The composite article according to claim 14, wherein said metal reinforcement element is a steel wire or a steel cord.

16. The composite article according to claim 14, wherein said metal reinforcement element is coated with a metal or metal alloy coating, e.g. zinc or a zinc alloy, before the adhesion promoting layer is applied.

17. The composite article according to claim 14, wherein said metal reinforcement element is an elongated element having an equivalent diameter in a range of 0.4 mm to 3.0 mm.

18. The composite article according to claim 14, wherein said polymer material is a polyolefin including polyethylene (PE), polypropylene (PP), polybutylene (PB), polyisobutylene, polymethylpentene (PMP), polybutene-1 (PB-1) and a copolymer of any of these polyolefins.

19. The composite article according to claim 14, wherein said acid anhydride-grafted polyolefin is maleic acid anhydride-grafted polyethylene.

20. The composite article according to claim 14, wherein said acid anhydride is present in said adhesion promoting layer in a concentration from 0.05 to 5.0 wt %.

21. The composite article according to claim 14, wherein said phenolic antioxidant is present in said adhesion promoting layer in a concentration lower than 5 wt %.

22. The composite article according to claim 14, wherein the thickness of said adhesion promoting layer is in a range from 5 to 500 μm.

23. A metal element for reinforcement of a polymer material, said metal reinforcement element being at least partially coated with an adhesion promoting layer, characterized in that said adhesion promoting layer comprises an acid anhydride-grafted polyolefin and a phenolic antioxidant selected from 2,6-di-tert-butyl-4-methylphenol, 2,6-di-tert-butylphenol, 2,6-d-tert-butyl-4-s-butylphenol, mixture of alkylated phenols or 4,4′-methylene-bis(2,6-di-ter-butylphenol) or a combination including any of the above phenolic antioxidants.

24. A method of manufacturing a composite article as defined in claim 14, said method comprising the steps of
a) providing a metal reinforcement element;
b) applying an adhesion promoting layer on at least a part of said metal reinforcement element, said adhesion promoting layer comprising an acid anhydride-grafted polyolefin and a phenolic antioxidant selected from 2,6-di-tert-butyl-4-methylphenol, 2,6-di-tert-butylphenol, 2,6-d-tert-butyl-4-s-butylphenol, mixture of alkylated phenols or 4,4′-methylene-bis(2,6-di-ter-butylphenol) or a combination including any of the above phenolic antioxidants;
c) embedding said metal reinforcement element coated with said adhesion promoting layer in a polymer material.

25. The method according to claim 24, further comprising the step of
d) applying a metal or metal alloy coating e.g. zinc or a zinc alloy, before the application of said adhesion promoting layer.

26. The use of a composite article as defined in claim 14 for furniture, drop cables, power transmission cables, automotive or constructions.
